(19) United States
(12) Patent Application Publication
(10) Pub. No.: US 2005/0217159 A1
(43) Pub. Date: Oct. 6, 2005

(54) Teething toy with picture framing function

(76) Inventor: Dwight Leung, Fallbrook, CA (US)

Correspondence Address: FISH & RICHARDSON, PC, 12390 EL CAMINO REAL, SAN DIEGO, CA, 92130-2081, US

(21) Appl. No.: 10/817,518

(22) Filed: Apr. 1, 2004

(51) Int. Cl. G02F 1/13; A47G 1/06

(52) U.S. Cl. 40/725

(57) ABSTRACT

A teething device that allows a picture to be inserted into the device.

### BACKGROUND

Devices for aiding infants in the teething process are common. As children grow and develop teeth, they often like to chew on a variety of objects. Teethers can be provided to divert children from chewing on items that might, for example, be swallowed or that might injure them.

In addition, infants enjoy looking at photographs of people and things they know. Photograph and card holders are also common in the art. However, these photograph and card holders are designed as decorative elements, to display photographs or collectable sports cards. They are typically not designed for small children's use or play.

For example, U.S. Pat. No. D419,309 to Leon describes a figurine photograph holder that warns of choking hazard to children under 3 on its packaging.

Another example is U.S. Pat. No. 5,522,163 to Neugebauer which describes a sport card holder that may have sharp edges and also contains small parts that could pose a choking hazard to a small child.

### SUMMARY

A teething toy which includes a picture framing function is disclosed. An outer frame defines surfaces adapted for teething by a child and adapted for holding a paper based picture therein, much like a picture frame.

Another aspect defines a teething toy with a flexible portion, including a first housing, having first surfaces defining lip surfaces for a picture holding assembly, second surfaces defining a hanging location, third surfaces defining teething portions, and a rigid picture holding assembly, defining surfaces for holding the picture, and outer surfaces that fit within the inner surfaces of the first housing.

### BRIEF DESCRIPTION OF THE DRAWINGS

These and other aspects will be described with reference to the following drawings, in which:

FIGS. 1a, 1b, and 2-5 show a first embodiment of the picture holding teething device which has an openable portion to allow the picture holding frame to be inserted and removed;

FIGS. 6a, 6b and 7-10 show a second embodiment which is not openable, and is in a substantially square shape; and

FIG. 11 and 12 show alternate shapes.

### DETAILED DESCRIPTION

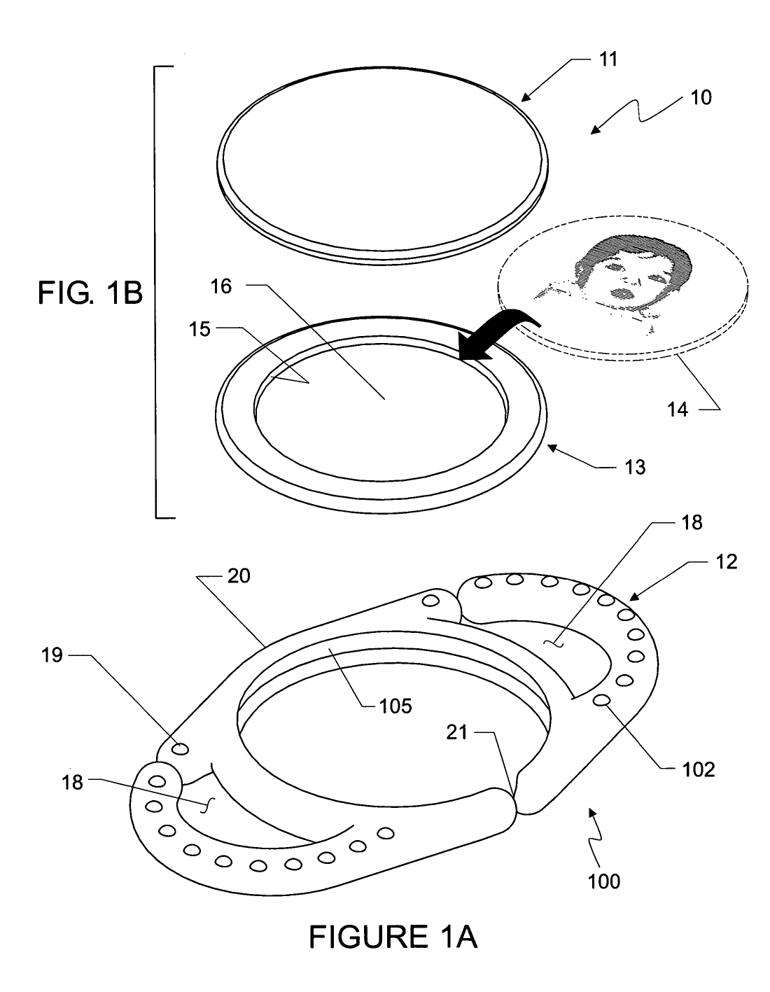

A first embodiment is shown in FIGS. 1A, 1B, and 2-5. This embodiment has a round frame shape, and defines a perimeter that opens to insert a frame device therein.

The basic toy 100 includes two parts: the flexible frame 12, and the rigid picture holding part 10. The flexible frame 12 is formed of a non-toxic, flexible yet durable material such as silicone or polypropylene. This material can be any material, however, with sufficient resiliency to enable it to be used by a child for teething. The cover assembly 10 is formed of a nontoxic clear material such as polyethylene which has more rigidity than the material of the frame 12.

The picture holding part 10 includes front cover 11 and rear cover 13. Covers 11 and 13 fit together along a lip surface 15 which holds the covers in registration relative to one another, and also leaves an open area 16 in between the two covers, leaving space for the framed item 14. Since both top cover 11 and bottom cover 13 are clear, the framed item 14 location in the open area 16 can be viewed from both top and bottom sides.

In this embodiment, framed item 14 may be a picture, a piece of art, or any item which can be contained on any piece of paper or comparable sized element.

In the first embodiment, the frame 12 is openable: it can be opened entirely. Once opened, the picture holding assembly can be fit within a lip surface 105, defined within the perimeter defined by the frame 12.

The opening part is defined by hinge parts 20 and 21. FIG. 5 shows how the frame 12 is hinged open by bending along the hinge area 20 to force the split 21 further apart. This enlarges the opening size of the split, and allows the picture holding assembly 10 to be inserted therein. The picture holding assembly 10 is then held within the lip surfaces 105 defined within the frame perimeter.

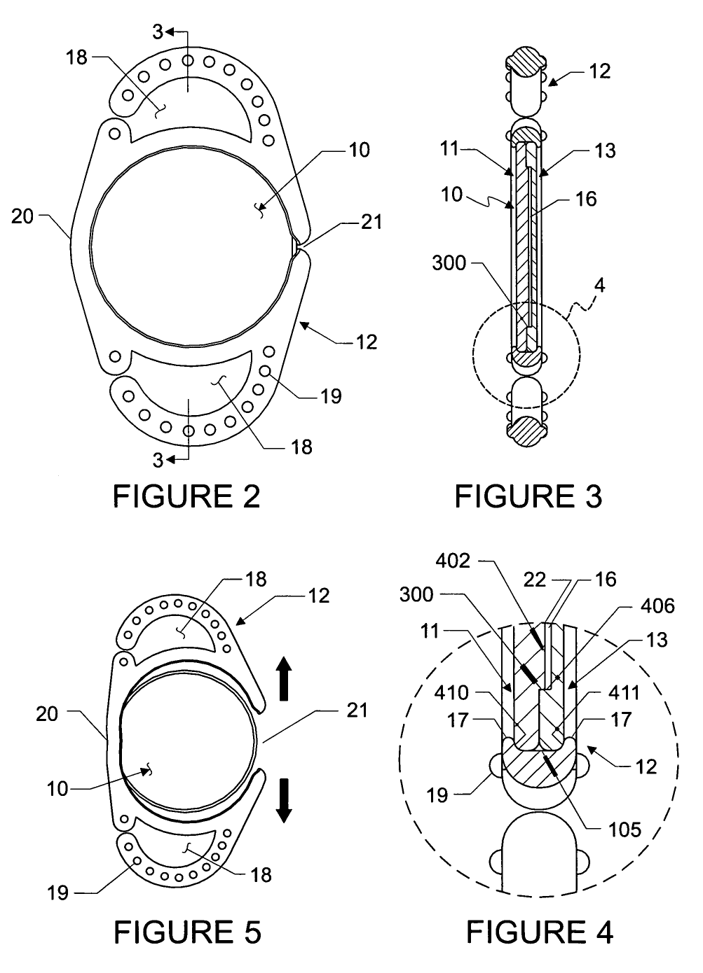

FIG. 2 shows the assembled device with the picture holding portion 10 within the frame portion 12.

A holding portion 18 defines a surface to which a string or the like can be attached to hold the toy 100, e.g. to a stroller or the like.

The top cover 11 includes a protrusion 22 on its flat surface that engages the lid of the bottom cover securing the framed item 14. FIG. 3 shows a cross-section along the line 3-3 in FIG. 2. The cover assembly 10 is shown with the front cover and rear cover 11 and 13. The front cover has a protruding portion 300 which fits within a corresponding bevel within rear portion 13. A small space 16 is defined between the top and bottom cover is used to hold the framed item 14 therein.

FIG. 4 shows a detail of the area 4 in FIG. 3. This shows further detail on the bevel connection 300 and how the downward facing part of the bevel 402 on front cover 11 is shorter than the depth of the corresponding indentation 406 in rear cover 13. This leaves the space 16, within which the framed item 14 is located.

FIG. 4 also shows further details on the lip surfaces 105 of the frame 12. These surfaces 105 are substantially half-moon-shaped in cross section, to hold against the edges of the picture holding part 10. Importantly, the inner surfaces defining the lip surface 105 include a first surface portion 410 that faces a second surface portion 411. The two facing surface portions respectively apply pressure against the front and rear surface of the picture holding device 10, maintaining the two sides of the picture holding device against one another.

In use, a child can chew on any part of the frame 12 or picture holding part 10, although the picture holding part 10 may be more rigid and therefore less appealing to be chewed. The framed item 14 can be seen by the child at any position. At least one bump surface 19 can be provided to facilitate the teething experience.

In an alternative environment, the flexible outer frame is not openable as in the first embodiment. In this case, the frame is formed of a softer material, such as 60 Shore A, that can be more easily stretched to fit the inner part of the frame around the picture holding part. The picture holding part should be larger than the inner surfaces defining the frame, for example 2 to 3 mm larger overall. This enables the frame to be stretched open, and the inner cover 620 to be held in place by the tight fit.

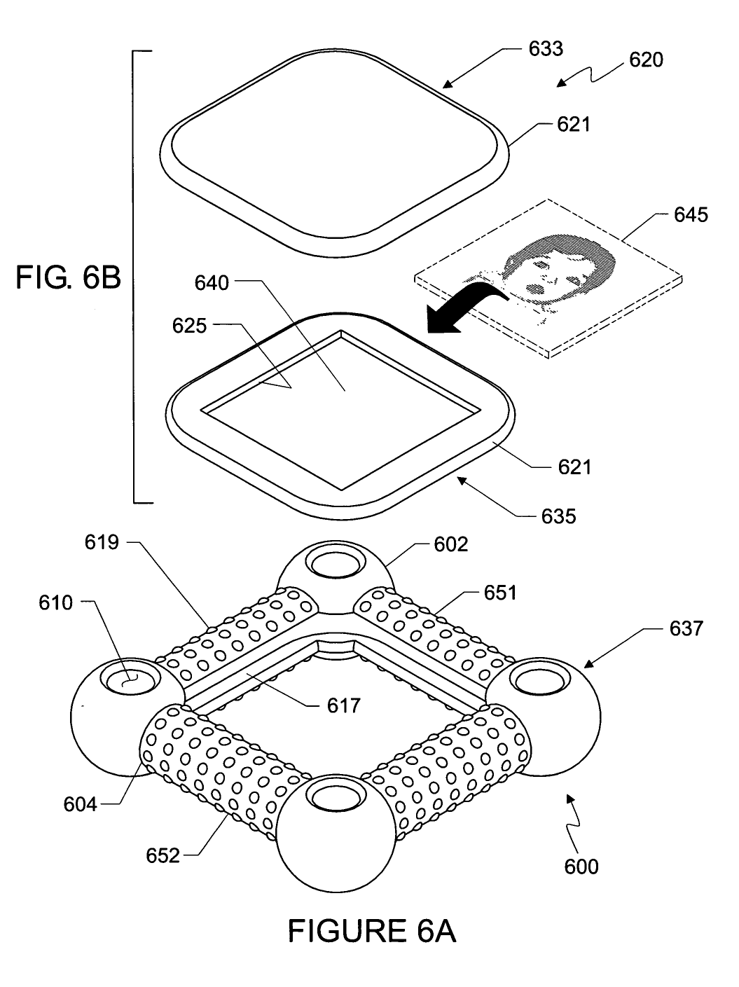

FIGS. 6A and 6B show the second embodiment with the non-openable frame. As in the first embodiment, the basic toy 600 includes two parts: the flexible frame 637, and the rigid picture holding part 620. The FIGS. 6A and 6B embodiment has a substantially square outer perimeter. In the embodiment, a number of substantially flat rounded portions extending along straight lines 652, are bounded by a number of substantially rounded portions 602. Even though the basic shape is generally square, it has rounded edge portions at 604 to avoid sharp edges being presented to the child.

610 shows the holding portion in the embodiment of FIG. 6A, which includes holes formed within the edge pieces defining the edges of the perimeter, which holes form the holding portion, here 610. As above, holding portions 610 can be used for a string connection to a stroller or the like. The FIG. 6 embodiment also includes inner lip surfaces 617, which are sized relative to the picture holding assembly 620. The picture holding assembly 620 here is substantially square with rounded edges, as shown, to fit within the inner surfaces 617. The picture holding assembly has, as in the first embodiment, a top cover 633, a bottom cover 635, and is formed with a top rounded edge 621 on its top cover 633 and bottom cover 635, and inner beveled edges defining a space 640 within which the picture 645 can be located.

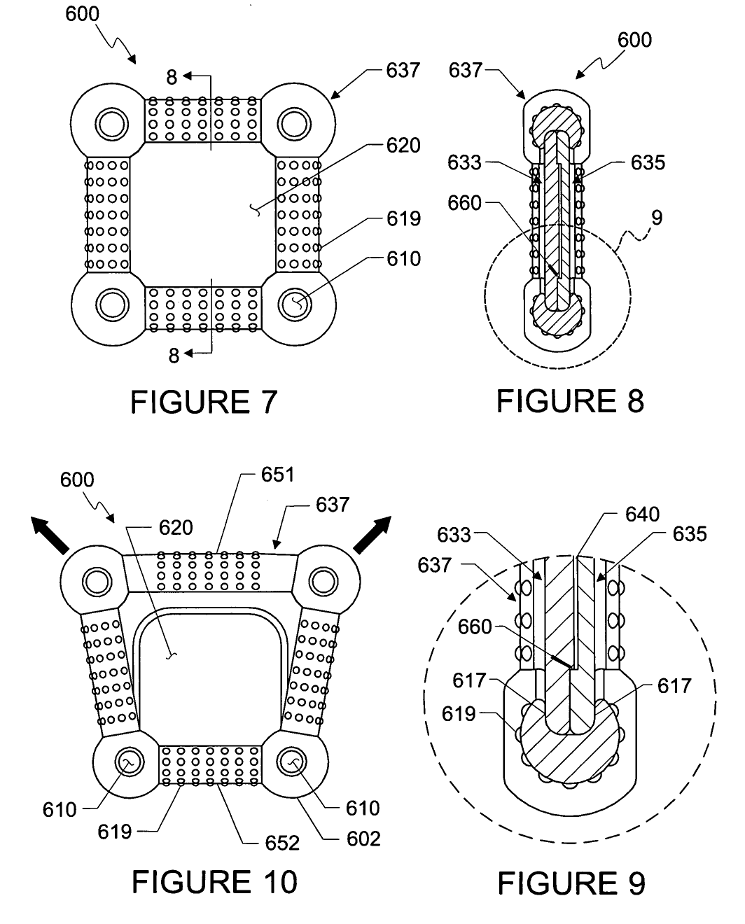

FIG. 10 illustrates how the cover assembly is placed within the frame in this embodiment. First, a portion of the frame 637 is stretched near its top portion. This causes one portion of the frame 651 to be stretched relative to the other portion of the frame 652. The frame also hinges along the edge supports 602. The cover portion or picture holding assembly 620 is then placed within the lip surfaces 617 of the frame, preferably first at the bottom, and then the frame is released. The assembled device 600, with the frame 637 therein is shown in FIG. 7. A cross-section of this device is shown in FIG. 8, with a detailed section of the cross section shown in FIG. 9. As in the first embodiment, the lip portion 617 forms a substantially partial cylindrical shape, of the shape adapted to hold the beveled outer edges of the picture holding portion against one another. The picture holding portion also includes two beveled portions, shown as 660, and defines a space for the picture, as in the first embodiment.

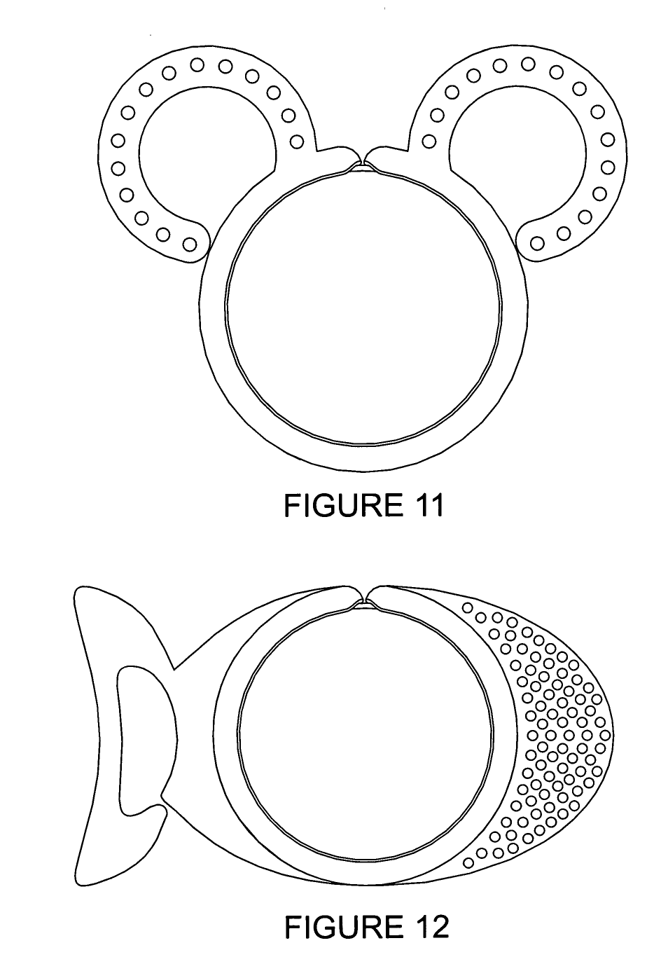

Alternative environments may allow the device to be located in other shapes. FIG. 11 shows that the device is located with an alternative shape in the shape of mouse ears.

FIG. 12 shows the shape being generally in the shape of a fish. In these alternative environments, a hinge/opening configuration is used; however it should be understood that alternative environments may use any shape, and either hinged opening or stretched opening.

In each of these embodiments, there is a teething area, a connection area, and end plurality of surfaces which define where the picture can be maintained.

Other implementations are contemplated. For example, although the above describes specific shapes, it should be understood that other shapes besides the specific shapes could be used. The above has described the shapes being round, rectangular, square, fish shaped, and mouse shaped. More generally, any shape of any type can be used, so long as the shape includes a continuous bounded perimeter within which the rigid cover can be placed.

Also, the picture holding portion can be a single connected piece with an open edge, for example, as an alternative to the completely separable portions.

All such modifications are intended to encompass within the following claims, in which:

1. A teething toy comprising:
a housing portion, formed of a material which is flexible and soft and having at least one surface adapted for teething by an infant, and having at least a second lip surface defining a perimeter, having first and second facing surfaces;
a picture holding portion, formed of substantially rigid and transparent material, formed of a front portion, a rear portion, and an area defined between said front portion and said rear portion adapted for holding a printed picture;
said second lip surface defining an area which overlaps and covers and holds said front portion and said rear portion of said picture holding portion, said area being over at least 90% of a perimeter of said picture holding portion.

2. A toy as in claim 1, wherein said second lip surface extends continuously surrounding said perimeter.

3. A toy as in claim 1, wherein said second lip surface extends around only a portion of a perimeter, and defines an openable portion at a first area thereof.

4. A toy as in claim 1, wherein said perimeter is substantially a round shape.

5. A toy as in claim 1, wherein said perimeter is substantially a square shape with rounded edges.

6. A toy as in claim 1, wherein said front portion of said picture holding portion includes a first beveled area which mates with a second beveled area on said rear portion, each of said first and second beveled area extending over a perimeter of each of said front portion and said rear portion respectively.

7. A toy as in claim 6, wherein one of said beveled areas is longer than another of said beveled areas, leaving a space between said front portion and said rear portion.

8. A teething toy as in claim 1, wherein said at least one surface include bumps thereon.

9. A teething toy as in claim 3, wherein said front and rear surfaces of said picture holding portion include beveled areas thereon.

10. A method, comprising:
placing a picture between first and second sheets of clear and rigid material; and
placing the first and second sheets of clear and rigid material within lip surfaces defining a perimeter, within a frame forming a teething device for a child.

11. A method as in claim 10, wherein said placing comprises separating two portions of the surface defining a perimeter within said teething device, and placing said first and second sheets within said perimeter.

12. A method as in claim 10, wherein said placing comprises stretching the perimeter and placing said sheets within the stretched perimeter.

13. A method as in claim 10, wherein said first and second sheets are round, and said perimeter is round.

14. A method as in claim 10, wherein said first and second sheets are substantially square with rounded edges, and said perimeter is substantially square with rounded edges.

15. A method as in claim 10, wherein said placing the picture between first and second sheets comprises placing a picture in a space defined between said first and second sheets.

16. A toy comprising:
a housing portion, formed of a flexible material adapted for teething by an infant, and including an outer surface including a plurality of bumps thereon, said outer surface also defining a toy holding loop, within which a connection is adapted to be attached, and including inner surfaces defining a perimeter, said inner surfaces having a lip portion in which a first portion of the inner surface faces a second portion of the inner surface, and a picture holding part, including a front cover, a rear cover, a space defined between the front and rear covers, a picture in a space between the front and rear covers, and shaped to fit within said perimeter such that said first portion of the inner surface presses against a front cover, and a second portion of the inner surface presses against the rear cover holding the front and rear covers together.
